(19) United States
(12) Patent Application Publication
(10) Pub. No.: US 2015/0110476 A1
(43) Pub. Date: Apr. 23, 2015

(54) LOW COST METHOD OF TEMPORARY IN STORE PRODUCT ADVERTISING FOR RETAIL STORES

(71) Applicant: Brian B. Walker, Big Lake, MN (US)

(72) Inventor: Brian B. Walker, Big Lake, MN (US)

(21) Appl. No.: 14/060,500

(22) Filed: Oct. 22, 2013

(51) Int. Cl. G06Q 30/02; H04N 5/93; G11B 31/00; H04N 5/775

(52) U.S. Cl. CPC G06Q 30/0251; H04N 5/775; H04N 5/93; G11B 31/00; G06Q 30/0272
USPC 386/359

(57) ABSTRACT

A low cost method of temporary in store product advertising comprising the steps of creating a repeatable video and audio advertisement of a product, placing repeatable video and audio advertisement in a plurality of inexpensive stand-alone battery powered flash memory video players, generating a list of retail stores for receiving the plurality flash memory video players to each of retail stores on the list of retail stores, placing at least one of the flash memory video players proximate products promoted in the repeatable video and audio advertisement and within arms-length of potential customer, repeatedly activating repeatable video and audio advertisement in response to customer interaction with one of the flash memory video players or in response to a message repeat signal, and removing at least one of the flash memory video players from proximate product either at the end of a product advertising period or when a battery fails.

### FIELD OF THE INVENTION

This invention relates to product and services advertisement and product and services information and more specifically to a low cost method of temporary in store product advertising for retail stores located in different geographical areas.

### CROSS REFERENCE TO RELATED APPLICATIONS

None

### STATEMENT REGARDING FEDERALLY SPONSORED RESEARCH OR DEVELOPMENT

None

### REFERENCE TO A MICROFICHE APPENDIX

None

### SUMMARY OF THE INVENTION

The present invention comprises a low cost method of temporary in store product advertising for retail stores located in different geographical areas and a product thereof and a system for temporary in store product advertising for retail stores located in different geographical areas.

The low cost method of temporary in store product advertising for retail stores located in different geographical areas comprising the steps of creating a repeatable video and audio advertisement of a product; placing the repeatable video and audio advertisement of the product in a plurality of inexpensive stand-alone battery powered flash memory video players; generating a list of retail stores for receiving the plurality of inexpensive stand-alone battery powered flash memory video players; delivering one or more of the plurality of the inexpensive battery powered flash memory video players to each of the retail stores on the list of retail stores; placing at least one of the plurality of inexpensive stand-alone battery powered flash memory video players proximate the product promoted in the repeatable video and audio advertisement and within arms-length of a potential customer; repeatedly activating the repeatable video and audio advertisement in response to customer interaction with one of the plurality of stand-alone battery powered flash memory video players or in response to a message repeat signal; and removing at least one of the plurality of battery powered flash memory video players from proximate the product either at the end of a product advertising period or when a battery fails.

The present invention also includes an inexpensive stand-alone battery powered flash memory video player comprising an electronic display means, a flash memory storage unit, and a flash memory storage unit storing a repeatable video and audio advertisement of a product. The stand-alone battery powered flash memory video player also includes a video player connecting the flash memory storage unit with the electronic display means and functioning to access the repeatable video and audio advertisement of the product stored on the flash memory unit and play the repeatable video and audio advertisement on the repeatable video and audio advertisement of a product on demand, a rechargeable or non-rechargeable battery for powering the stand-alone battery powered flash memory video player, and a set of graphics located on a front face and/or proximal the front face of the video player to induce a customer to watch the video and audio advertisement on said video player. It is noted that the set of graphics may be a part of the overall stand-alone battery powered flash memory video player such as located on the housing of the stand-alone battery powered flash memory video player forming for example a container or cardstock housing or comprises a separate unit that may either be connected to the stand-alone battery powered flash memory video player or positioned proximal in a space-apart condition with the stand-alone battery powered flash memory video player.

The present invention further includes a system for temporary in store product advertising for retail stores located in different geographical areas comprising the steps of working with a product manufacturer to create a repeatable video and audio advertisement of a product; working with the product manufacturer create a set of graphics to induce a customer to watch the video and audio advertisement; and forwarding said repeatable video and audio advertisement of a product and said set of graphics to a video player manufacturer; providing the video player manufacturer with instructions on incorporating the repeatable video and audio advertisement of a product and the set of graphics into the production and design of a plurality of inexpensive stand-alone battery powered flash memory video players. The aforementioned system may also include the step of providing the video player manufacturer with instructions on where to send the plurality of inexpensive stand-alone battery powered flash memory video players.

### BRIEF DESCRIPTION OF THE DRAWINGS

FIG. 1 is a back view showing of the general components that make up an inexpensive stand-alone battery powered flash memory video player;

FIG. 2 shows a cross-sectional of the inexpensive stand-alone battery powered flash memory video player of FIG. 1;

FIG. 3 is a perspective view showing an inexpensive stand-alone battery powered flash memory video player comprising a product display shelf panel;

FIG. 4 is a perspective view showing an inexpensive stand-alone battery powered flash memory video player comprising a vertical hanging banner;

FIG. 5 is a perspective view showing a product display shelf having an attachment member located on a backside of the product display shelf panel;

FIG. 6 is a perspective view showing an inexpensive stand-alone battery powered flash memory video player comprising a stand-alone product display sign;

FIG. 7 is a perspective view showing an inexpensive stand-alone battery powered flash memory video player comprising a foldable advertisement sign sheet;

FIG. 8 is a perspective view showing an inexpensive stand-alone battery powered flash memory video player comprising a box housing in storage or transporting condition;

FIG. 9 is a perspective view showing a box housing being converted from the storage or transporting condition to an upright customer viewable condition; and

FIG. 10 is a perspective view showing a flap of box housing folded to form a kickstand support for maintaining the box housing in the upright customer viewable condition.

### DESCRIPTION OF THE PREFERRED EMBODIMENT

In the field of in store product advertising for retail stores, a large number of methods and devices exist to convey information about a product brand. Unfortunately, most of these devices and methods are physical and static in nature, such as the traditional posters, cards and placards placed proximate the products which may often times have difficulty in attracting the consumer's attention. However, such advertising displays have the benefit of being inexpensive to both produce and maintain. Since such advertising displays are inexpensive the displays can be disposed at the end of a product advertising period.

Electronic based devices such as kiosks, programmable overhead projectors and large LCD and LED television screens, which deliver video and audio advertisement of products to the consumer at retail stores outlet are effective in not only attracting but also capturing the consumer's attention. However, the aforementioned electronic based devices usually have bulky hardware which generally require a fixed installation proximal a power source in the retail outlet. In addition the display screens are relatively expensive to not only purchase but also set up and maintain as they generally require specialized technicians to install the advertising messages as well as provide periodic maintenance and repair of the devices. If a retailer, producer, manufacturer or other trader of branded products or services has outlets in multiple locations, the cost of purchasing and maintaining the aforementioned electronic based devices may increase exponentially. In addition, if the outlets are located in remote or semi-remote locations, it may be difficult to obtain a technician to perform not only periodic maintenance and repair but also to install the messages to be delivered.

A feature of the invention described herein is that it provides a low cost advertising display as well as a low cost method of temporary in store product advertising for retail stores, which may be located in different geographical areas. A further feature of the invention is the electronic and static advertisement of a product that is installed in the advertising display may be created, installed, and manufactured in a different geographical area and then delivered to retail stores where the advertising displays can be set on or proximate a product shelf by an unskilled worker. Further features of the invention described herein is that the aforementioned advertising display provides, an advertising or information display that is relatively inexpensive to manufacture, that is both a static and repeatable video/audio advertisement; that can be supplied at little or no costs to the retail store that can be delivered to the retail store outlets in a ready to use condition. That is, no specialized technician is required to install any messages and no repairs and maintenance is required since the advertising display device is in a self contained housing and when the advertising program is finished may be mailed back to a recycler when the battery in the advertising display is discharged or when the advertising display becomes inoperable due to damage or when the adverting program is completed.

A further feature of the present invention is that since the aforementioned device is intended as a replacement for the traditional store product advertising items such as posters, cards and placards that are placed around or proximate products, the device may be set easily set up by any employee of the retail store outlet who is familiar with the static advertising displays.

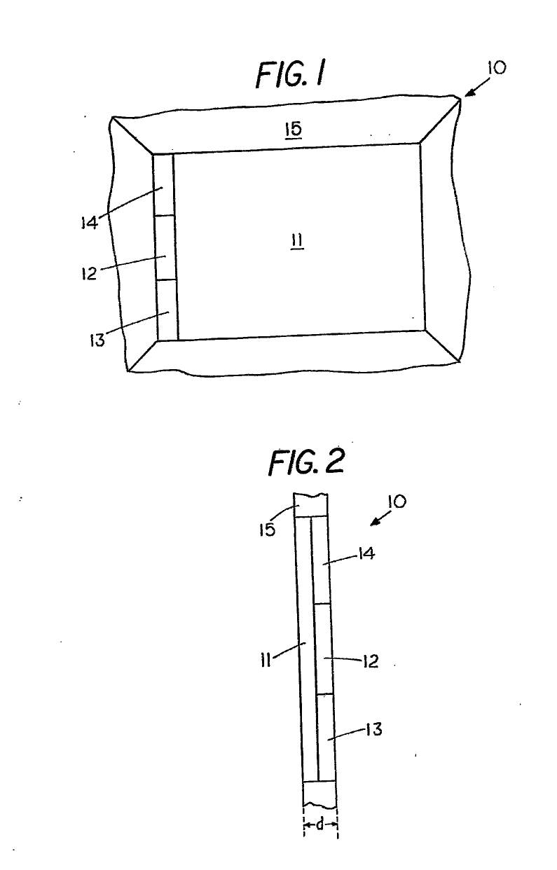

Referring to FIGS. 1 and 2, FIG. 1 is a back view and FIG. 2 is a cross-sectional view showing the components that co-act to form a lightweight, portable, inexpensive stand-alone battery powered flash memory video player 10 that may be used for a low cost method of temporary in store product advertising for retail stores which may be located in different geographical areas. The term “inexpensive” as used herein refers to the cost of manufacturing the video display which is about the same as the cost of manufacturing a traditional static advertising display, which are commonly found in retail store. In contrast, an example of an “expensive” display are the video displays such as the television or video monitors which require programming the video monitor with the advertising information. It is further noted that the term product used herein is not limited to a product or services having some type of brand value or desirous of obtaining a brand value.

Typically, the inexpensive stand-alone battery powered flash memory video player 10 includes an electronic display screen 11 preferably having a depth “d” of less than 1 centimeter so as to use as the same amount of shelf space as conventional static advertising material. An example of electronic display screen 11 may include but is not limited to an ultra-thin and slightly flexible LCD or LED screen which may have touch screen capabilities.

The stand-alone battery powered flash memory video player 10 also includes a flash memory storage unit 12, which functions to store a repeatable video and audio advertisement of a product that may be filed in various formats including but not limited to AVI, Real Video, MP3/MP4, Quick Time™, MPEG1, MPEG2, and MPEG4 thereon. It is noted that flash memory storage unit 12 may comprise single-level cell based memory such as those found in solid-state drives or multi-level cell memory such as those found in USB drives. Although flash memory storage unit 12 may be tailored in capacity to fulfill the need of the size of the video and audio advertisement files, it is preferred that a playing time of the video and audio advertisement is less than a minute since the life of the battery is of limited duration and the unit is either disposed of or recycled after the battery fails.

Connecting electronic display screen 11 to flash memory storage unit 12 is a video player 13, which has the ability to access the repeatable video and audio advertisement stored on flash memory storage unit 12 and play the repeatable video and audio advertisement on electronic display screen 11 on demand. By “on demand” it is meant that stand-alone battery powered flash memory video player 10 may be activated directly by a consumer, activated by a motion sensor, activated by sound or the various combinations. Although stand-alone battery powered flash memory video player 10 is designed to play one repeatable video and audio advertisement of the product on electronic display screen 11 on demand, alternative embodiments may include a stand-alone battery powered flash memory video player having the capability of playing multiple repeatable video and audio advertisement of a product on the electronic display means based on consumer interaction via a touch screen or for some form of push buttons.

A feature of the present invention is that stand-alone battery powered flash memory video player 10 does not use an external power source and is self-powered by a battery and preferably a low cost rechargeable or non-rechargeable battery 14, which are typically disposed after being discharged. Although the life of stand-alone battery powered flash memory video player 10 may vary depending upon use, the life of the stand-alone battery powered flash memory video player 10 preferably is use driven rather than time driven. That is, life of the stand-alone battery powered flash memory video player 10 is based on the life of battery 14, which may typically last for a period of 2-3 weeks since the video player requires the battery to operate. The life of the stand-alone battery powered flash memory video player 10 may also be limited by, the number of cycles/use or playing time of the repeatable video and audio advertisement of the product and is dependent on the duration of the video display since the video display consumes energy from the battery.

A feature relating to the cost of the present invention is that once the battery 14 is discharged the battery cannot be recharged by user and the stand-alone battery powered flash memory video player 10 is either disposed of or preferably sent to a recycler for recycling. Examples of suitable batteries for powering stand-alone battery powered flash memory video player include but are not limited to primary (single-use or “disposable”) batteries and thin film solid-state smart battery that are integral to the flash memory storage unit 12. Thus, the maximum life of the advertising display is limited by the life of the battery powering the display.

In the example shown the stand-alone battery powered flash memory video player 10 includes a set of graphics 15 on a front face 10a of flash memory video player 10 to induce customers to watch the video and audio advertisement on flash memory video player 10. The set of graphics 15 on flash memory video player 10 may also include LED lights thereon to further attract consumers to watch the video and audio advertisement on flash memory video player 10.

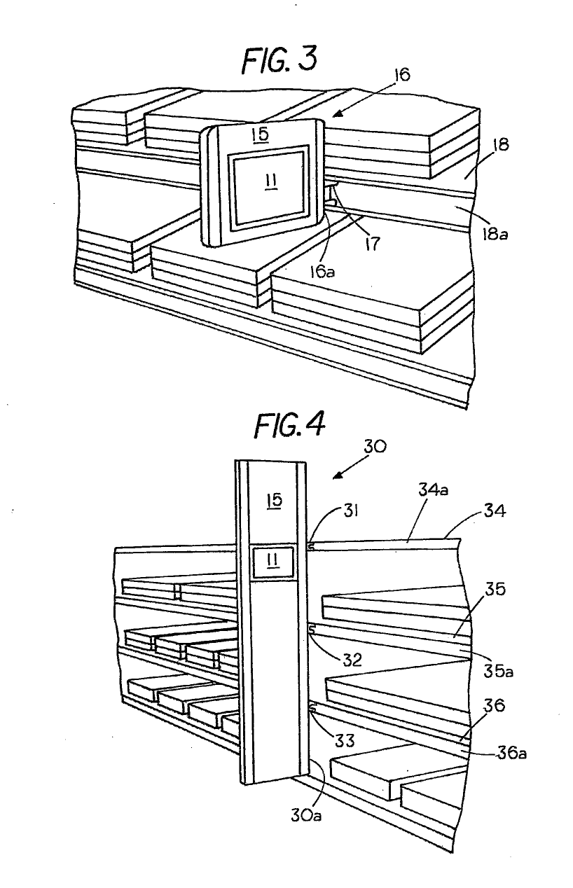

FIG. 3 is a perspective view showing an embodiment of an inexpensive stand-alone battery powered flash memory video player comprising a product display shelf panel 16 having all the components of the stand-alone battery powered flash memory video player 10 of FIGS. 1 and 2. However, product display shelf panel 16 also includes an attachment member 17 located on a side 16a of product display shelf panel 16 for cantileverly mounting product display shelf panel 16 to an edge or to a front face 18a of a retail store product display shelf 18 to enable the panel to deliver a repeatable video and audio advertisement regarding the information and qualities of the adjacent products to a customer proximate the display shelf. In the example shown the attachment member 17 include a set of ears that resiliently interfit into the existing label rail to enable the panel 16 to be quickly attached to the shelf without the aid of tools.

FIG. 4 is a perspective view showing another example of an inexpensive stand-alone battery powered flash memory video player comprising a vertical hanging banner 30 similar in parts to the product display shelf panel 16 of FIG. 3. However, due to the length of vertical hanging banner 30, vertical hanging banner 30 may include a plurality of attachment members 31, 32, 33 located on a side 30a of vertical product display shelf banner 30 for temporary cantileverly supporting vertical hanging banner 30 proximate the edges or to the front rail faces 34a, 35a, 36a of retail store product display shelves 34, 35, 36 thus enabling the video player to deliver a repeatable video and audio advertisement regarding the information and qualities of the products proximate the video player.

FIG. 5 is a perspective view showing another example of an inexpensive stand-alone battery powered flash memory video player comprising a product display shelf panel 19 similar to the product display shelf panel 16 of FIG. 3. However, product display shelf panel 19 includes an attachment member 20 comprising a pair of wire hooks which are secured to a back side 19a of product display shelf panel 19 for temporary securement of the video player to an edge of retail store product display shelves for delivery of a repeatable video and audio advertisement regarding the information and qualities of the products proximate the video player.

FIG. 6 is a perspective view showing another example of an inexpensive stand-alone battery powered flash memory video player comprising a stand-alone product display sign 21 having all the components of the stand-alone battery powered flash memory video player 10 of FIG. 1. Stand-alone product display sign 21 includes a stand 22 having a support base and support rod for temporarily supporting stand-alone product display sign 21 adjacent to a retail store product display area such as a product display shelf for delivering a repeatable video and audio advertisement regarding the information and qualities of the adjacent products.

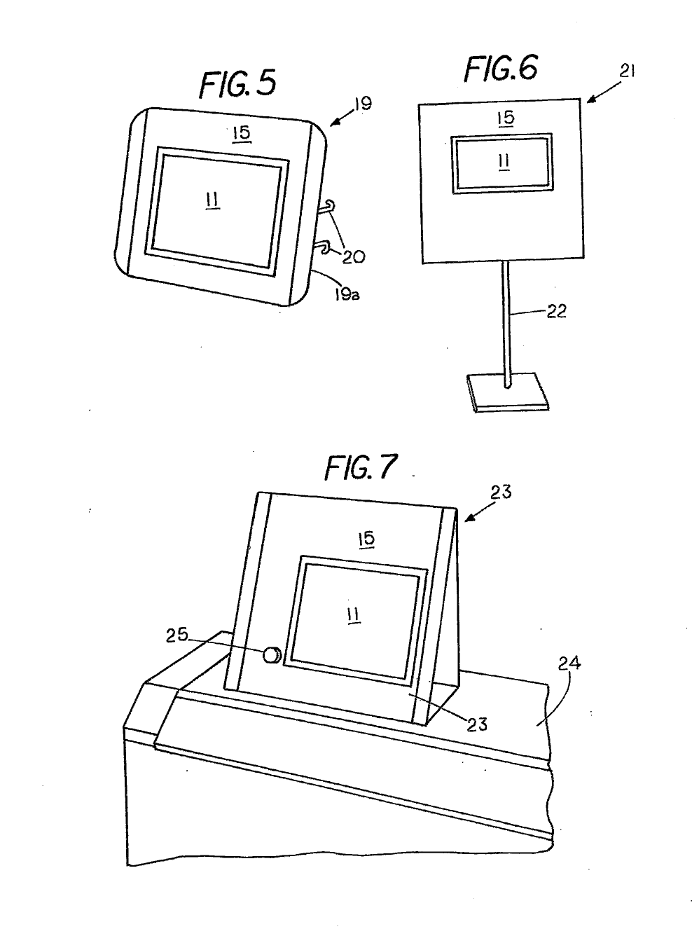

FIG. 7 is a perspective view showing another example of an inexpensive stand-alone battery powered flash memory video player comprising a foldable advertisement sign sheet 23 having all the components of the stand-alone battery powered flash memory video player 10 of FIG. 1. Foldable advertisement sign sheet 23 is shown supported on a retail store product display shelf 24 with the electronic display screen 11 supported on a first side 23a of foldable advertisement sign sheet 23, which is the side of foldable advertisement sign sheet 23 that is intended to face the consumer while the display screen is supported on shelf 24. As shown in FIG. 6, foldable advertisement sign sheet 23 also includes a switch 25 for activation by a consumer for the delivery of a repeatable video and audio advertisement regarding the information and qualities of the products proximate the display screen 11.

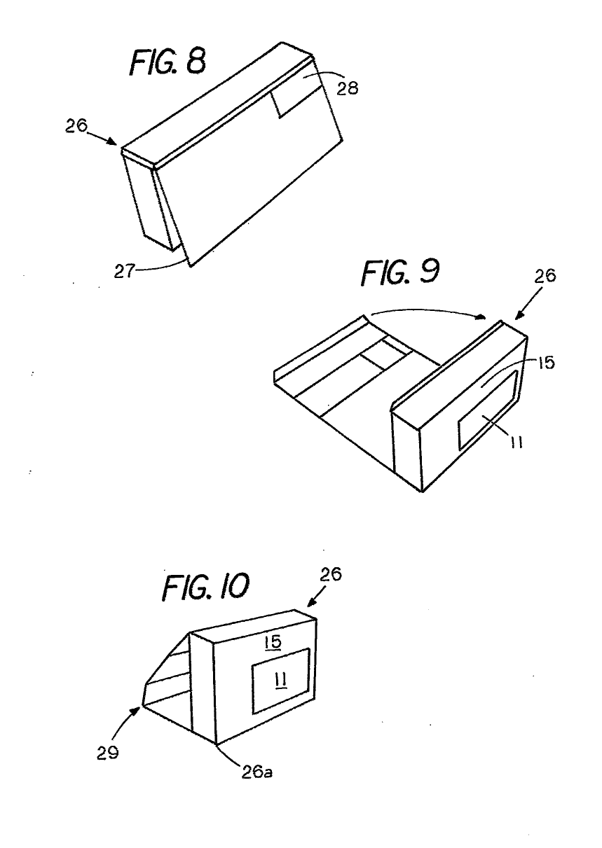

FIGS. 8, 9, and 10 are a perspective views showing a further example of an inexpensive stand-alone battery powered flash memory video player comprising a rectangular shaped box housing 26 having a front face 26a supporting electronic display screen 11 thereon (shown in FIG. 10). Box housing 26 includes an integral flap 27 hingedly connected to box housing 26. Flap 27 is shown in FIG. 8 covering electronic display screen 11 when box-housing 26 is in a storage or transporting condition to help protect the surface of electronic display screen 11 from damage. Referring to FIGS. 9 and 10, a feature of box housing 26 is that flap 27 may be foldable between a first position covering the electronic display screen 11 and a second position to form a leg or kickstand 29 as shown in FIG. 10. The leg 29 helps support and maintain the box housing 26 in an upright customer viewable condition on a retail store product display shelf, a table or a countertop for delivering a repeatable video and audio advertisement regarding the information and qualities of the products proximate the display screen 11.

Box housing 26 also includes a mailing label 28 located on the exterior surface of box housing 26, which is normally not visible to the customer watching the video and audio advertisement on electronic display screen 11. Although mailing label 28 may be located at various locations on box housing 26, mailing label 28 FIG. 6 shows mailing label 28 located on flap 27, which is outside the viewing sight of the customer watching the video and audio advertisement on electronic display screen 11. On the other hand the label is visible to postal or delivery workers when the flap on box housing 26 is folded into a transporting condition.

The invention described herein also includes the implementation of inexpensive stand-alone battery powered flash memory video player 10 to create the low cost method of temporary in store product advertising for retail stores located in different geographical areas with the steps (1) creating a repeatable video and audio advertisement of a product; (2) placing the repeatable video and audio advertisement of the product in a plurality of inexpensive stand-alone battery powered flash memory video players 10; (3) generating a list of retail stores for receiving the plurality of inexpensive stand-alone battery powered flash memory video players 10; (4) delivering one or more of the plurality of the inexpensive battery powered flash memory video players 10 to each of the retail stores on the list of retail stores; (5) placing at least one of the plurality of inexpensive stand-alone battery powered flash memory video players 10 proximate the product promoted in the repeatable video and audio advertisement and within arm's length of a potential customer; (6) repeatedly activating the repeatable video and audio advertisement in response to customer interaction with one of the plurality of stand-alone battery powered flash memory video players 10 or in response to a message repeat signal; and (7) removing at least one of the plurality of battery powered flash memory video players 10 from proximate the product either at the end of a product advertising period or when a battery 14 fails.

The low cost method of temporary in store product advertising for retail stores located in different geographical areas may also include the steps of (8) placing a mailing label 28 on a box 26 containing at least one stand-alone battery powered flash memory video players 10; (9) placing the repeatable video and audio advertisement of the product in a plurality of inexpensive stand-alone battery powered multi-level cell memory video players; (13) placing the repeatable video and audio advertisement of the product in a plurality of inexpensive stand-alone battery powered single-level cell memory video players; (14) placing a mailing label 28 on a box 26 containing at least one stand-alone battery powered flash memory video players 10 with the mailing label 28 in a position not readily visible to the potential customer; (15) placing a mailing label 28 on a box 26 containing at least one stand-alone battery powered flash memory video players 10 before delivery of the box 26 to a retail store; (16) delivering the stand-alone battery powered flash memory video players 10 to a recycler after completion of the product advertising period; (17) placing the repeatable video and audio advertisement of the product in a plurality of inexpensive stand-alone battery powered flash memory video players 10 wherein a playing time of the video and audio advertisement is less than a minute.

The low cost method of temporary in store product advertising for retail stores located in different geographical areas may also include the steps of (19) placing the repeatable video and audio advertisement of the product in a plurality of inexpensive stand-alone battery powered flash memory video players 10 wherein each of the stand-alone battery powered flash memory video player 16,19 includes an attachment 17,20 for cantileverly mounting the stand-alone battery powered video player 16,19 to an edge of a retail store product shelf 18; (20) placing the repeatable video and audio advertisement of the product in a plurality of inexpensive stand-alone battery powered flash memory video players 10 wherein each of the stand-alone battery powered flash memory video player includes a switch 25 for customer activation of the video and audio advertisement; (21) placing the repeatable video and audio advertisement of the product in a plurality of inexpensive stand-alone battery powered flash memory video players 10 wherein each of the battery powered flash memory video players 10 include a set of graphics 15 on a front face 10a of each of the stand-alone battery powered flash memory video player 10 to induce a customer to watch the video and audio advertisement on the stand-alone battery powered flash memory video players 10; (22) repeatedly activating the repeatable video and audio advertisement in response to either a customer initiation or a predetermined event; and (23) extending a flap 27 on the box 26 to form a support 29 for maintaining the box 26 in an upright customer viewable position.

The invention also includes a system for temporary in store product advertising for retail stores located in different geographical areas comprising the steps of (1) working with a product manufacturer to create a repeatable video and audio advertisement of a product; (2) working with the same product manufacturer to create a set of graphics design to induce a customer to watch the video and audio advertisement; (3) forwarding the repeatable video and audio advertisement of the product and the set of graphics design to a video player manufacturer; providing the video player manufacturer with instructions on incorporating the repeatable video and audio advertisement of the product and the set of graphics design into the production and design of a plurality of inexpensive stand-alone battery powered flash memory video players 10; and (4) providing the video player manufacturer with instructions on where to send the plurality of inexpensive stand-alone battery powered flash memory video players 10.

The above system for temporary in store product advertising for retail stores located in different geographical areas may also include the steps of forwarding the repeatable video and audio advertisement of the product and the set of graphics design to a video player manufacturer via the Internet and providing the video player manufacturer with instructions on incorporating the repeatable video and audio advertisement of the product and the set of graphics design into the production and design of a plurality of inexpensive stand-alone battery powered flash memory video players 10 via the internet.

I claim:

1. A low cost method of temporary in store product advertising for retail stores located in different geographical areas comprising the steps of:
creating a repeatable video and audio advertisement of a product;
placing the repeatable video and audio advertisement of the product in a plurality of inexpensive stand-alone battery powered flash memory video players;
generating a list of retail stores for receiving the plurality of inexpensive stand-alone battery powered flash memory video players;
delivering one or more of the plurality of the inexpensive battery powered flash memory video players to each of the retail stores on the list of retail stores;
placing at least one of the pluralities of inexpensive stand-alone battery powered flash memory video players proximate the product promoted in the repeatable video and audio advertisement and within arm's length of a potential customer;
repeatedly activating the repeatable video and audio advertisement in response to customer interaction with one of the plurality of stand-alone battery powered flash memory video players or in response to a message repeat signal; and
removing at least one of the pluralities of battery powered flash memory video players from proximate the product either at the end of a product advertising period or when a battery fails.

2. The method of claim 1 including placing a mailing label on a box containing the at least one stand-alone battery powered flash memory video players before delivery of the box to a retail store with the label located in a position not readily visible to the potential customer.

3. The method of claim 1 wherein the plurality of battery powered flash memory video players is each powered by a thin film rechargeable solid-state smart battery.

4. The method of claim 1 wherein a playing time of the video and audio advertisement is less than a minute.

5. The method of claim 1 wherein each of the stand-alone battery powered flash memory video player includes at least one attachment member for cantileverly mounting the stand-alone battery powered video player to an edge of a retail store product display shelf.

6. The method of claim 1 wherein each of the stand-alone battery powered flash memory video player includes a switch for customer activation of the video and audio advertisement.

7. The method of claim 1 including a set of graphics on a front face of each of the stand-alone battery powered flash memory video player to induce a customer to watch the video and audio advertisement on the stand-alone battery powered flash memory video players.

8. The method of claim 1 wherein the stand-alone battery powered flash memory video players repeats the video and audio advertisement in response to either a customer initiation or a predetermined event.

9. The method of claim 2 including extending a flap on the box to form a support for maintaining the box in an upright customer viewable position.

10. An inexpensive stand-alone battery powered flash memory video player comprising:
an electronic display means;
a flash memory storage unit located in said electronic display means, said flash memory storage unit storing a repeatable video and audio advertisement of a product;
a video player connected to said flash memory storage unit for accessing and playing said repeatable video and audio advertisement on demand;
a rechargeable or non-rechargeable battery for powering said video player; and
a set of graphics on a front face of said video player to induce a customer to watch said video and audio advertisement on said video player.

11. The stand-alone battery powered flash memory video player of claim 10 wherein the battery comprises a thin film rechargeable solid-state smart battery that is integral to the flash memory storage unit.

12. The stand-alone battery powered flash memory video player of claim 10 including at least one attachment member for cantileverly mounting said video player to a retail store product display shelf.

13. The stand-alone battery powered flash memory video player of claim 10 wherein said video player includes a switch for customer activation of the video and audio advertisement.

14. The stand-alone battery powered flash memory video player of claim 11 including a box housing having a surface supporting said video player thereon wherein said a mailing label is located on said box outside a viewing sight of the customer to watch said video and audio advertisement on said video player.

15. The stand-alone battery powered flash memory video player of claim 14 including a flap on the box to form a kickstand support for maintaining the box in an upright customer viewable position.

16. The stand-alone battery powered flash memory video player of claim 10 wherein said video player includes a touch screen.

17. The stand-alone battery powered flash memory video player of claim 10 wherein said video player is consumer, motion, or sound activated.

18. The stand-alone battery powered flash memory video player of claim 10 wherein said set of graphics on said front face of said video player includes LED lights to attract consumers.

19. A system for temporary in store product advertising for retail stores located in different geographical areas comprising the steps of:
working with a product manufacturer to create a repeatable video and audio advertisement of a product;
working with said product manufacturer to create a set of graphics design to induce a customer to watch said video and audio advertisement;
forwarding said repeatable video and audio advertisement of a product and said set of graphics design to a video player manufacturer;
providing said video player manufacturer with instructions on incorporating said repeatable video and audio advertisement of a product and said set of graphics into the production and design of a plurality of inexpensive stand-alone battery powered flash memory video players; and
providing said video player manufacturer with instructions on where to send said plurality of inexpensive stand-alone battery powered flash memory video players.

20. The system of claim 19 wherein said instructions to said video player manufacturer are forward to said video player manufacture.
